(19) United States
(12) Patent Application Publication
(10) Pub. No.: US 2023/0405862 A1
(43) Pub. Date: Dec. 21, 2023

(54) 3/16 PITCH MICRO SAW CHAIN OF MOTOR DRIVEN SAW CHAIN

(71) Applicant: ZHEJIANG TRILINK HUIHUANG CO.,LTD, Jinhua (CN)

(72) Inventors: ZHIHUO ZHAO, Lishui (CN); FUZHEN HU, Lishui (CN)

(21) Appl. No.: 17/844,790

(22) Filed: Jun. 21, 2022

(51) Int. Cl. B27B 33/14

(52) U.S. Cl. CPC B27B 33/142

(57) ABSTRACT

The present disclosure belongs to technical field of gardening tools, relates to 3/16 pitch micro saw chain of motor driven saw chain. It saw chain of motor driven saw chain is composed of left gear cutting chain sheet, right gear cutting chain sheet, side connecting sheet and transmission sheet with transmission function by riveting chain shaft. The width A of saw line is confirmed by upper cutter point of left/right gear cutting chain sheet and width A of saw line is 4.4-5.4 mm. A maximum height C is confirmed from bottommost end of transmission sheet with transmission function top highest part of left/right gear cutting chain sheet, maximum height C is 8.5-9.8 mm. An average pitch is confirmed by hole pitch T1 of transmission sheet with transmission and hole pitch T2 of side connecting sheet, left and right gear cutting chain sheet, T(T1+T2)/2=4.76 mm, S=178-252 mm3. The present disclosure has higher cutting efficiency, light weight, easy operation, no easy shaking during use, smooth section, stronger stability, safety, lower power consumption.

### TECHNICAL FIELD

The present disclosure belongs to the technical field of gardening tools, in particular relates to a 3/16 pitch micro saw chain of a motor driven saw chain.

### BACKGROUND

With the gradual popularization of a saw chain, the using environment of the saw chain is gradually extended to home. However, due to great specification, heavy weight and the like, most existing saw chains are no longer suitable for the using demand of the new environment. At present, the newest small-pitch and lightweight motor driven saw chain at home and abroad is a ¼ saw chain. The characteristic is that the saw chain with smaller specifications and the light weight can be achieved by selecting a smaller saw line, a maximum height and an average pitch. However, such design cannot completely meet the lightweight demand in the new environment.

### SUMMARY

For the above deficiencies in the prior art, the present disclosure provides a 3/16 pitch micro saw chain of a motor driven saw chain, so as to solve the above problem.

In order to solve the above purpose, the present disclosure adopts the technical solution below:

A 3/16 pitch micro saw chain of a motor driven saw chain is composed of a left gear cutting chain sheet, a right gear cutting chain sheet, a side connecting sheet and a transmission sheet with a transmission function by riveting a chain shaft, wherein the width A of a saw line is confirmed by an upper cutter point of the left gear cutting chain sheet/the right gear cutting chain sheet and the width A of the saw line is 4.4-5.4 mm; the maximum height C is confirmed from the bottommost end of the transmission sheet with the transmission function to the highest part of the left gear cutting chain sheet/the right gear cutting chain sheet, and the maximum height C is C1+C2=8.5-9.8 mm; and the average pitch T is confirmed by a hole pitch T1 of the transmission sheet with the transmission function and a hole pitch T2 of the side connecting sheet and the left gear cutting chain sheet/the right gear cutting chain sheet, and T=(T1+T2)/2=4.76 mm, S=A*C*T=178-252 mm3.

Further, the thickness of the left gear cutting chain sheet/the right gear cutting chain sheet is 1.0 mm, and the ejecting amount is 1.6-2.1 mm.

Further, the thickness of the transmission sheet with the transmission function is 1.1 mm.

Further, the height of a rivet head of a pin shaft is 0.3-0.4 mm.

Further, T2>T1.

Further, C1>C2.

Further, the pitch T2/T1 of the 3/16 pitch micro saw chain is 1.15-1.2 mm.

Compared with the prior art, the present disclosure has the following beneficial effects:

The 3/16 pitch micro saw chain provided by the present disclosure has light weight, easy operation and convenient carrying; further the saw chain size is reduced and the pitch is shortened, so the saw chain is not easy to shake during use and the section is smoother, with stronger stability and safety and lower energy consumption. At the same time, a stamping and bending angle of the left gear cutting sheet/the right gear cutting sheet is optimized, and then the cutting amount and the discharge space are adjusted to achieve the cutting efficiency for ensuring the working operation of 3/16 pitch micro saw chain.

### BRIEF DESCRIPTION OF DRAWINGS

FIG. 1 is a structure diagram of an embodiment of a 3/16 pitch micro saw chain of a motor driven saw chain in the utility model.

FIG. 2 is a front view of a connecting sheet in an embodiment of a 3/16 pitch micro saw chain of a motor driven saw chain in the utility model.

FIG. 3 is a side view of a connecting sheet in an embodiment of a 3/16 pitch micro saw chain of a motor driven saw chain in the utility model.

FIG. 4 is a front view of a right gear cutting sheet in an embodiment of a 3/16 pitch micro saw chain of a motor driven saw chain in the utility model.

FIG. 5 is a side view of a right gear cutting sheet in an embodiment of a 3/16 pitch micro saw chain of a motor driven saw chain in the utility model.

FIG. 6 is a front view of a transmission sheet with a transmission function in an embodiment of a 3/16 pitch micro saw chain of a motor driven saw chain in the utility model.

FIG. 7 is a side view of a transmission sheet with a transmission function in an embodiment of a 3/16 pitch micro saw chain of a motor driven saw chain in the utility model.

FIG. 8 is a section view of A-A in an embodiment of a 3/16 pitch micro saw chain of a motor driven saw chain in the utility model.

Reference signs in the drawings of the specification include:

Right gear cutting chain sheet 1, side connecting sheet 2, right gear cutting chain sheet 3, chain shaft 4, transmission sheet 5 with transmission function, thickness 6 of side connecting sheet, thickness 7 of left gear cutting chain sheet and right gear cutting chain sheet, ejecting amount 8 of left gear cutting chain sheet and right gear cutting chain sheet, thickness 9 of transmission sheet with transmission function, height 10 of rivet head, width A of saw line, distance C1 from the central hole of the left gear cutting chain sheet/the right gear cutting chain sheet to the highest point of the gear, distance C2 from the central line of the transmission sheet hole with the transmission function to the top of gear hook, pitch T1 of the transmission sheet with the transmission function, and pitch T2 of the left gear cutting chain sheet, the right gear cutting chain sheet and the side connecting sheet.

### DETAILED DESCRIPTION

In order to make those skilled in the art understand the present disclosure better, the technical solutions in the present disclosure are further described below in combination with the drawings and embodiments.

The drawing is only illustrative description, showing a schematic diagram rather than an actual diagram, so it is not understood as a limitation to the present disclosure. In order to explain the embodiments of the present disclosure better, some parts in the drawing may be omitted, amplified or reduced, which will not represent the actual product size. Those skilled in the art can understand the omitted common structures and the description in the drawing.

### Embodiment

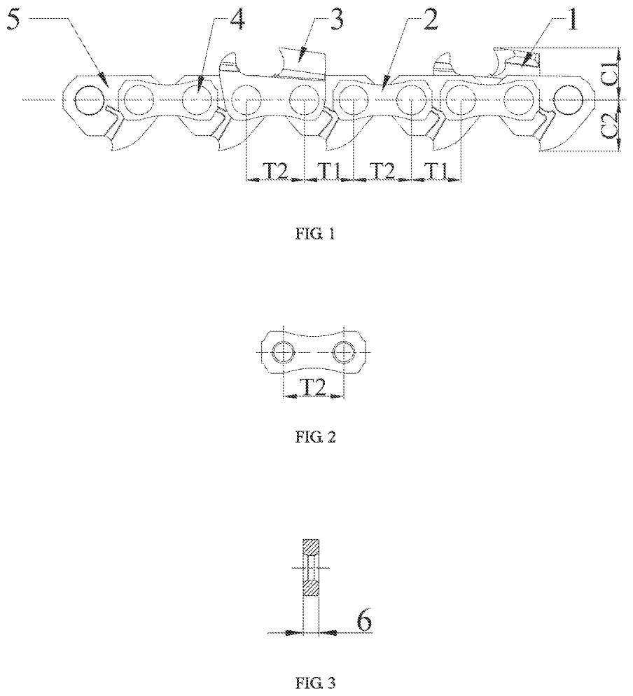

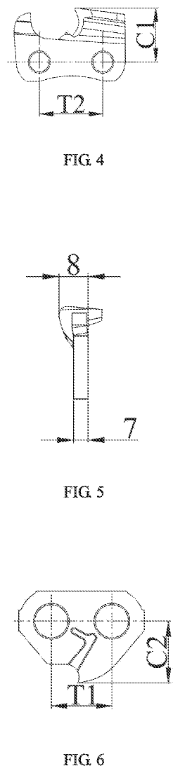

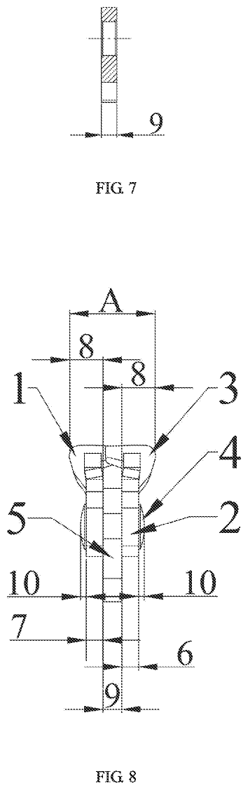

As shown in FIG. 1-FIG. 8, a 1/16 pitch micro saw chain of a motor driven saw chain provided by the present disclosure is composed of a left gear cutting chain sheet 3, a right gear cutting chain sheet 1, a side connecting sheet 2 and a transmission sheet 5 with a transmission function by riveting a chain shaft 4. The width A of a saw line is confirmed by an upper cutter point of the left gear cutting chain sheet and the right gear cutting chain sheet and the width A of the saw line is 4.4-5.4 mm; the maximum height C is confirmed from the bottommost end of the transmission sheet with the transmission function top the highest part of the left gear cutting chain sheet and the right gear cutting chain sheet, and the maximum height C is C1+C2=8.5-9.8 mm; and the average pitch is confirmed by a hole pitch T1 of the transmission sheet with the transmission function and a hole pitch T2 of the side connecting sheet and the left gear cutting chain sheet and the right gear cutting chain sheet, and T=(T1+T2)/2=4.76 mm, S=A*C*T=178-252 mm3.

Specifically, during use, in order to meet a smaller specification and weight, the thickness 8 of the left gear cutting chain sheet and the right gear cutting chain sheet is 1.0 mm, the ejecting amount 8 is 1.6-2.1 mm, the thickness 6 of the side connecting sheet is 1.0 mm, the thickness 9 of the transmission sheet with the transmission function is 1.1 mm, the pitch of the transmission sheet with the transmission function is T1, the pitch of the left gear cutting chain sheet, the right gear cutting chain sheet and the side connecting sheet is T2, and T2/T1 is 1.15-1.2; and the distance from the central hole of the left gear cutting chain sheet and the right gear cutting chain sheet to the highest point of the gear cutting is C1, the distance from the central line of the transmission sheet with the transmission function to the top point of the gear hook is C2, and C1+C2 is 8.5-9.8 mm, C1>C2.

In addition, the height 10 of the rivet head of the pin shaft is 0.3-0.4 mm, and the pitch T2/T1 of the 3/16 pitch micro saw chain is 1.15-1.2 mm.

The above is only the embodiment of the present disclosure. The common specific structure, characteristic and other common senses in the solution are not described more herein. Those of ordinary skill in the art know all common technical knowledge in the technical field of the present disclosure before the application date or the priority date, can get all existing technologies in this field, and have the ability of applying the conventional experimental means before this date. Those of ordinary skill in the art may improve and implement the solution under the enlightenment of this application and in combination with their own abilities. Some typical common structures or common methods should not be an obstacle to the implementation of this application by those of ordinary skill in the art. It is to be pointed out that those skilled in the art may further make a plurality of transformations and improvements without departing from the structure of the present disclosure and all of these fall within the scope of protection of the present disclosure, and these will not affect the implementation effect of the present disclosure and the practicality of the present disclosure.

The same or similar signs in the drawings of the embodiments of the present disclosure correspond to the same or similar parts. In the description of the present disclosure, it is understood that orientation or position relationships indicated by the terms “upper”, “lower”, “front”, “rear”, “left”, “right”, “vertical”, “horizontal”, “top”, “bottom”, “inner”, “outer” and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms for describing the positions in the drawings are only for illustrative description, not be understood as limitations to the present disclosure. Those of ordinary skill in the art can understand the specific meanings of the above terms according to the specific conditions.

In the disclosure, unless specific regulation and limitation otherwise, terms “install” and the like should be generally understood, for example, may a detachable connection, or integrated, may a mechanical connection or an electric connection, may a direct connection or an indirect connection through an intermediation, and may an internal connection of two elements or an interactive relationship of two elements. Those of ordinary skill in the art may understand the specific meaning of the terms in the present disclosure according to specific conditions.

What is claimed is:

1. A 3/16 pitch micro saw chain of a motor driven saw chain is composed of a left gear cutting chain sheet, a right gear cutting chain sheet, a side connecting sheet and a transmission sheet with a transmission function by riveting a chain shaft, wherein the width A of a saw line is confirmed by an upper cutter point of the left gear cutting chain sheet/the right gear cutting chain sheet and the width A of the saw line is 4.4-5.4 mm; the maximum height C is confirmed from the bottommost end of the transmission sheet with the transmission function top the highest part of the left gear cutting chain sheet/the right gear cutting chain sheet, and the maximum height C is C1+C2=8.5-9.8 mm; and the average pitch is confirmed by a hole pitch T1 of the transmission sheet with the transmission function and a hole pitch T2 of the side connecting sheet and the left gear cutting chain sheet/the right gear cutting chain sheet, and T=(T1+T2)/2=4.76 mm, S=A*C*T=178-252 mm3.

2. The 3/16 pitch micro saw chain of the motor driven saw chain according to claim 1, wherein the thickness of the left gear cutting chain sheet/the right gear cutting chain sheet is 1.0 mm, and the ejecting amount is 1.6-2.1 mm.

3. The 3/16 pitch micro saw chain of the motor driven saw chain according to claim 2, wherein the thickness of the transmission sheet with the transmission function is 1.1 mm.

4. The 3/16 pitch micro saw chain of the motor driven saw chain according to claim 3, wherein the height of a rivet head of a pin shaft is 0.3-0.4 mm.

5. The 3/16 pitch micro saw chain of the motor driven saw chain according to claim 4, wherein T2>T1.

6. The 3/16 pitch micro saw chain of the motor driven saw chain according to claim 5, wherein C1>C2.

7. The 3/16 pitch micro saw chain of the motor driven saw chain according to claim 6, wherein the pitch T2/T1 of the 3/16 pitch micro saw chain is 1.15-1.2 mm.
